(19) United States
(12) Patent Application Publication
(10) Pub. No.: US 2016/0359199 A1
(43) Pub. Date: Dec. 8, 2016

(54) SPECIFIC LITHIUM BATTERIES COMPRISING NON-AQUEOUS ELECTROLYTES BASED ON SULFONE COMPOUNDS

(71) Applicant: RENAULT S.A.S, Boulogne-Billancour (FR)

(72) Inventors: Herve GALIANO, La Ville Aux Dames (FR); Matthieu LE DIGABEL, Monts (FR); Agnes BILLER, Saint Avertin (FR); Nelly PENOT, Monts (FR); Jean Frederic MARTIN, Renage (FR); Christophe DUDEZERT, Paris (FR)

(73) Assignee: RENAULT S.A.S, Boulogne-Billancour (FR)

(21) Appl. No.: 15/117,213

(22) PCT Filed: Feb. 4, 2015
(86) PCT No.: PCT/FR2015/050268

§ 371 Date: Aug. 8, 2016

(30) Foreign Application Priority Data
Feb. 6, 2014 (FR) 1450928

(51) Int. Cl. H01M 10/0569; H01M 4/525; H01M 4/485; H01M 4/505; H01M 10/0525; H01M 10/0567

(52) U.S. Cl. CPC H01M 10/0569; H01M 10/0525; H01M 10/0567; H01M 4/485; H01M 4/505; H01M 4/525; H01M 2300/0037

(57) ABSTRACT

The invention relates to lithium batteries comprising at least one electrochemical cell comprising an electrolyte conducting lithium ions comprising at least one sulfone solvent, at least one additive selected from among anhydride compounds and at least one lithium salt, which electrolyte is positioned between a positive electrode comprising, as an active material, a lithiated oxide of formula LiNi_{0.4}Mn_{1.6}O₄ or LiNi_{0.5}Mn_{1.5}O₄ and a negative electrode comprising, as an active material, Li₄Ti₅O₁₂.

### TECHNICAL FIELD

The present invention relates to specific lithium batteries comprising non-aqueous electrolytes based on at least one sulfone solvent and one or several specific additives, these batteries being more specifically lithium-ion batteries.

Lithium batteries are of particular interest for fields where autonomy is a primordial criterion, such as this is the case in the fields of computer science, video, mobile telephones, transports such as electric vehicles, hybrid vehicles, or further in the medical, space, microelectronics fields.

From a functional point of view, lithium-ion batteries are based on the principle of insertion-deinsertion of lithium within the constitutive materials of the electrodes of electrochemical cells of the battery.

More specifically, the reaction at the origin of the production of current (i.e. when the battery is in a discharge mode) sets into play the transfer, via an electrolyte conducting lithium ions, lithium cations from a negative electrode which will be inserted into the acceptor lattice of the positive electrode, while electrons from the reaction at the negative electrode will supply the outer circuit, to which are connected the positive and negative electrodes.

These electrolytes may consist in a mixture comprising at least one organic solvent and at least one lithium salt for ensuring conduction of said lithium ions, which requires that the lithium salt be dissolved in said organic solvent.

Lithium salts currently used may be LiPF₆, LiCO₄, LiAsF₆, LiBF₄, LiRSO₃, LiN(RSO₂)₂, LiC(RSO₂)₂ (R being a fluorine atom or a perfluoroalkyl group comprising from 1 to 8 carbon atoms), lithium trifluoromethanesulfonylimide (LiTFSI), lithium bis(oxalato)borate (LiBOB), lithium bis(perfluoroethylsulfonylimide) (LiBETI), lithium fluoroalkylphosphate (LiFAP), these lithium salts are conventionally dissolved in a mixture of organic solvents based on cyclic and/or linear carbonates. Such electrolytes have high conductivity (for example, greater than 1 mS/cm) and good electrochemical performances in a window of potentials ranging from 0 to 4.2V (expressed relatively to Li⁺/Li). Beyond 4.2V, as explained in J. Electrochem. Soc., 138, (1991) 2864, these electrolytic solutions are degraded by oxidation beyond this potential, which causes gas generation and deterioration of the performances of the battery expressed by partial or total self-discharge and a reduction in the lifetime.

In order to upgrade new electrode materials, which allow an increase in the capacity of the batteries, research work has focused on the design of new electrolytes based on solvent(s) which do not degrade when they are subject to high potential differences (for example, of the order of 5V).

As substitutes for the carbonate solvents mentioned above, sulfone solvents may be good candidates.

Sulfones may be divided into two groups: cyclic sulfones and linear sulfones, these sulfones may be described as symmetrical, when the groups located on either side of the —SO₂— group are identical or dissymmetrical, when the groups located on either side of the —SO₂— group are different.

As a cyclic sulfone, tetramethylsulfone (also known under the acronym of TMS) has already been studied for being used in electrolytic solutions for lithium batteries, and more specifically for lithium-ion batteries. In particular Watanabe et al. (Journal of Power Sources 179 (2008), 770-779) tested a mixture comprising TMS and ethyl acetate (in order to obtain a mixture with lesser viscosity than TMS alone) to which is added an additive (vinylene carbonate) with different pairs of electrodes: Li/LiCoO₂ and Li/LiNi_{0.5}Mn_{1.5}O₄ respectively. In spite of good chemical stability in oxidation, the results of cycling periods remain to be improved, since the electrochemical performances of the tested batteries decrease as the number of cycles increases. Also, the Coulomb efficiency (i.e., the ratio of the discharge capacity on that of the charging) also remains to be improved.

Linear sulfones have also been the subject of studies for application as electrolytes in lithium batteries.

More particularly, the dissymetrical sulfone, ethylmethylsulfone has demonstrated its efficiency in terms of electrochemical stability above 5V, notably when it is used with, as a lithium salt, LiPF₆ (as illustrated by Seel et al., J. Electrochem. Soc. 147(2000), 892). However ethylmethylsulfone, used alone has the drawback of being solid at room temperature, which restricts its use as a single solvent.

As a summary, in spite of the contribution of sulfones to the durability of a battery in particular operating at a high potential (for example, a potential of the order of 5V), there subsists a need for specific lithium batteries comprising an electrolyte based on sulfone solvent(s) which is able to solve notably the following problems:
self-discharge problems during storage, notably for batteries based on electrode pairs delivering a high voltage (for example, a voltage of more than 4.2V);
the lifetime of the batteries (for example, in terms of cyclability and Coulomb efficiency).

### DISCUSSION OF THE INVENTION

The authors of the present invention have discovered that by adding a specific additive to an electrolyte comprising at least one solvent from the family of sulfones, it is possible to meet the needs expressed above.

Thus, the invention relates to a lithium battery comprising at least one electrochemical cell comprising a conductive electrolyte of lithium ions comprising at least one sulfone solvent, at least one additive selected from among anhydride compounds and at least one lithium salt, said electrolyte is positioned between a positive electrode advantageously comprising as an active material, a lithiated oxide of formula LiNi_{0.4}Mn_{1.6}O₄ or LiNi_{0.5}Mn_{1.5}O₄ and a negative electrode advantageously comprising as an active material, Li₄Ti₅O₁₂.

It is specified that by positive electrode is conventionally meant, in the foregoing and in the following, the electrode which acts as a cathode, when the battery issues current (i.e. when it is in a discharge process) and which acts as an anode when the battery is in a charging process.

It is specified that by negative electrode is conventionally meant in the foregoing and in the following the electrode which acts as an anode, when the battery issues current (i.e. when it is in a discharge process) and which acts as a cathode, when the battery is in a charging process.

With such an association between the aforementioned electrolytes and the aforementioned pair of electrodes, the authors of the present invention were able to demonstrate a significant improvement in the performances of lithium batteries notably in terms of cyclability, self-discharge (this phenomenon being significantly reduced with the electrolytes of the invention) as compared with electrolytes comprising the same ingredients except for the presence of said additive. Furthermore, the improvement of its properties does not affect the durability of the batteries containing these electrolytes.

They were also able to demonstrate the synergy phenomenon by means of the aforementioned association, since the properties of the electrolytes in terms of cyclability and self-discharge are reinforced as compared with an electrolyte comprising the same additive but only with carbonate solvents.

Furthermore, the electrolytes comprised in the batteries of the invention have stability towards oxidation phenomena, notably when they are subject to potentials greater than 5 V expressed relatively to the Li⁺/Li pair.

Finally, the electrolytes comprised in the batteries of the invention give the possibility of giving the lithium batteries, into which they are incorporated, excellent results in terms of Coulomb efficiency.

As mentioned above, the electrolyte comprises at least one sulfone solvent, i.e. a solvent comprising at least one —SO₂— function.

This may be a sulfone solvent, which may be a cyclic sulfone solvent or further a linear sulfone solvent.

As examples of cyclic sulfone solvents, mention may be made of sulfone solvents fitting the following formula (I):

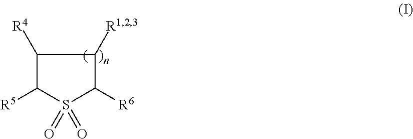

wherein:
R¹, R⁴, R⁵, R⁶ and if required R² and R³ represent, independently of each other, a hydrogen atom, a halogen atom (for example, a fluorine, chromium or bromine) or an alkyl group;
n is an integer ranging from 1 to 3, which means in other words that:
when n is equal to 1, the sulfone solvent fits the following formula (II):

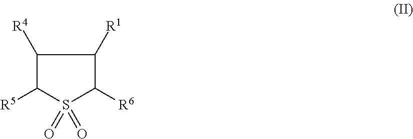

R¹, R⁴, R⁵ and R⁶ being as defined above;
when n is equal to 2, the sulfone solvent fits the following formula (III):

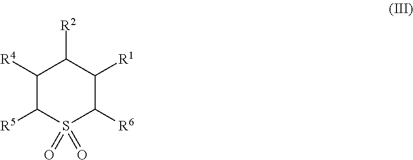

R¹ to R⁵ being as defined above;
when n is equal to 3, the sulfone solvent fits the following formula (IV):

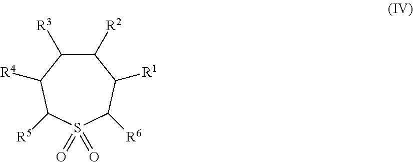

As specific examples of cyclic sulfone solvents, mention may be made of tetramethylsulfone (also known under the name of sulfolane) or 3-methylsulfolane.

The electrolyte may comprise a mixture of cyclic sulfones, for example a mixture of two cyclic sulfones.

When this is a linear sulfone solvent, this may be a symmetrical or asymmetrical linear sulfone solvent.

By “symmetrical”, is meant a linear sulfone solvent which comprises on either side of the —SO₂— group, identical groups.

By “asymmetrical”, is meant a linear sulfone solvent which comprises, on either side of the —SO₂— group, different groups.

As examples of a linear sulfone solvent, mention may be made of sulfone solvents fitting the following formula (V):

R⁷—SO₂—R⁸ (V)

wherein R⁷ and R⁸ represent, independently of each other, an alkyl group comprising from 1 to 7 carbon atoms optionally comprising one or several halogen atoms (for example, fluorine, chlorine or bromine atoms), an aryl group optionally comprising one or several halogen atoms (for example, fluorine, chlorine or bromine atoms).

For example R⁷ and R⁸ may represent, independently of each other, a methyl group (—CH₃), an ethyl group (—CH₂—CH₃), an n-propyl group (—CH₂—CH₂—CH₃), an n-butyl group (—CH₂—CH₂—CH₂—CH₃), an n-pentyl group (—CH₂—CH₂—CH₂—CH₂—CH₃), an n-hexyl group (—CH₂—CH₂—CH₂—CH₂—CH₂—CH₃), an n-heptyl group (—CH₂—CH₂—CH₂—CH₂—CH₂—CH₂—CH₃), an iso-propyl group (—CH(CH₃)₂), an iso-butyl group (—CH₂CH(CH₃)₂).

Specific linear sulfone solvents may be ethylmethylsulfone, di(n-butyl)sulfone, methylisopropylsulfone, ethylisopropylsulfone, diethylsulfone, di-n-propylsulfone, dimethylsulfone, 2-fluorophenylmethylsulfone.

Advantageously, the linear sulfone solvents may be ethylmethylsulfone (which may be designated by the acronym EMS), methylisopropylsulfone (which may be designated by the acronym MIS), these solvents have a high dielectric constant.

The sulfone solvent(s) may be comprised in the electrolyte in an amount from 10 to 90% by mass based on the mass of the electrolytes.

The electrolytes may comprise a single type of sulfone solvent or a mixture of sulfone solvents, which may notably make up a eutectic mixture giving the possibility of lowering the melting temperature of the constitutive solvents of the mixture.

The electrolytes may comprise, as solvent(s), exclusively one or several sulfone solvents but may also comprise one or several co-solvents, which are not sulfone solvents.

In particular, the co-solvent(s) may be carbonate solvents, such as:
linear carbonate solvents, such as dimethyl carbonate (known under the acronym of DMC), diethyl carbonate (known under the acronym of DEC), ethylmethylcarbonate (known under the acronym of EMC) or mixtures thereof;
cyclic carbonate solvents, such as ethylene carbonate (known under the acronym of EC), propylene carbonate (known under the acronym of PC) or mixtures thereof.

The linear carbonate solvents may be used for reducing the viscosity of the electrolyte, while the cyclic carbonate solvents may be used for contributing to the creation of a passivation layer at the surface of the electrodes, with which the electrolyte will be put into contact.

The list of carbonate solvents mentioned above is not exhaustive.

The electrolyte may comprise a single co-solvent or a mixture of co-solvents, this co-solvent or this mixture of co-solvents may be present in an amount from 10% to 90% by mass based on the total mass of the electrolyte.

Specific examples of mixtures of solvents which may enter the composition of the electrolyte are:
an EMS-DMC mixture (for example, in mass proportions 1:1);
an EMS-DEC mixture (for example, in mass proportions 1:1);
a TMS-DMC mixture (for example, in mass proportions 1:1);
an EC-EMS-DMC mixture (for example, in mass proportions 1:1:3);
an EMS-MIS-DMC mixture (for example, in mass proportions 2:3:5);
an EMS-EMC mixture (for example, in mass proportions 1:1); or
an MIS-DMC mixture (for example, in mass proportions 2:3).

As mentioned above, the electrolyte includes, as an essential element, an additive which is an anhydride compound.

More specifically, the additive may be a cyclic or acyclic carboxylic anhydride. More particularly, this may be a dicarboxylic anhydride. It may comprise one or several halogen atoms, such as fluorine, bromine or chlorine atoms. It may be used alone or as a mixture.

This additive may be present in the electrolyte according to a content ranging from 0.01% to 30% by mass based on the total mass of the electrolyte.

As examples, mention may be made of succinic anhydride (known under the acronym of AS), maleic anhydride (known under the acronym of AM), glutaric anhydride (known under the acronym of AG), phthalic anhydride (known under the acronym of APh), benzoic anhydride, ethanoic anhydride, propanoic anhydride, butanoic anhydride, cis-butenedioic anhydride, butane-1,4-dicarboxylic anhydride, pentane-1,5-dicarboxylic anhydride, hexane-1,6-dicarboxylic anhydride, 2,2-dimethylbutane-1,4-dicarboxylic anhydride, 2,2-dimethylpentane-1,5-dicarboxylic anhydride, 4-bromophthalic anhydride, 4-chloroformylphthalic anhydride, 3-methylglutaric anhydride, hexafluoroglutaric anhydride, acetic anhydride, trifluoroacetic anhydride, 2,3-dimethylmaleic anhydride, 2,3-diphenylmaleic anhydride, 2,3-pyrazinedicarboxylic anhydride, 3,3-tetramethyleneglutaric anhydride, difluorophthalic anhydride, benzoglutaric anhydride, phenylsuccinic anhydride, crotonic anhydride, isacoic anhydride, pentafluoropropionic anhydride, propionic anhydride, 3-fluorophthalic anhydride, itaconic anhydride, 2-methylenebutane-1,4-dicarboxylic anhydride and mixtures thereof.

Advantageously, the anhydride compound may be a succinic anhydride, which may be efficiently present in a content beginning with 0.1% by mass based on the total mass of the electrolyte and proving to be more efficient for a content of 1% by mass based on the total mass of the electrolyte.

The lithium salt as for it may be lithium hexafluorophosphate (LiPF₆), lithium perchlorate (LiClO₄), lithium tetrafluoroborate (LiBF₄), lithium trifluoromethylsulfonate, lithium bis(oxalato)borate (known under the acronym of LiBOB), lithium hexafluoroarsenate (LiAsF₆), bistrifluoromethylsulfonylimide (known under the acronym of LTFSI, a lithium perfluoroalkylphosphate, such as the one of formula LiP(CₙF₂ₙ₊₁)F₆₋ₓ wherein 0≦n≦10 and 0≦x≦6, lithium bis(perfluoroethylsulfonyl)imide (known under the acronym of LiBETI), lithium perfluoroalkylfluoroborate, as the one of formula LiB(CₙF₂ₙ₊₁)F₄₋ₓ wherein 0≦n≦10 and 5≦x≦4, lithium bis(trifluoromethanesulfonyl)imide (known under the acronym of LiLm), lithium (difluorooxalato)borate (LiBF₂C₂O₄), lithium bispentafluoroethylsulfonylimide. The lithium salt may be used alone or as a mixture.

Preferably, the lithium salt is LiPF₆, for example at a concentration of 1M.

Specific electrolytes according to the invention may be:
an electrolyte comprising an EMS-DMC mixture (for example in mass proportions 1:1), succinic anhydride (1% by mass based on the total mass of the electrolyte) and LiPF₆ 1M;
an electrolyte comprising an EMS-DEC mixture (for example in mass proportions 1:1), succinic anhydride (1% by mass based on the total mass of the electrolyte) and LiPF₆ 1M;
an electrolyte comprising a TMS-DMC mixture (for example in mass proportions 1:1), succinic anhydride (1% by mass based on the total mass of the electrolyte) and LiPF₆ 1M;
an electrolyte comprising an EC-EMS-DMC mixture (for example in mass proportions 1:1:3), succinic anhydride (1% by mass based on the total mass of the electrolyte) and LiPF₆ 1M;
an electrolyte comprising an EMS-MIS-DMC mixture (for example in mass proportions 2:3:5), succinic anhydride (1% by mass based on the total mass of the electrolyte) and LiPF₆ 1M;
an electrolyte comprising an EMS-EMC mixture (for example in mass proportions 1:1), succinic anhydride (1% by mass based on the total mass of the electrolyte) and LiPF₆ 1M; or
an electrolyte comprising a MIS-DMC mixture (for example in mass proportions 2:3), succinic anhydride (1% by mass based on the total mass of the electrolyte) and LiPF₆ 1M.

In particular, the electrolytes of the invention are particularly efficient in lithium batteries capable of providing a high voltage (for example, of the order of 5V per cell), these electrolytes thus being compatible with electrodes with a high potential.

In particular, the positive electrode advantageously comprises as a material for inserting lithium or an active material, a lithiated oxide of formula LiNi_{0.4}Mn_{1.6}O₄ or LiNi_{0.5}Mn_{1.5}O₄.

These materials are part of the general category of materials for inserting lithium, the discharge voltage of which is greater than 4.5V expressed relatively to the Li⁺/Li pair and more specifically, materials of the lithiated material type with a spinelle structure, these materials being known under the name of “spinelle 5V”, these materials more specifically entering the category of lithiated oxides comprising manganese with a spinelle structure of the following formula (VI):

LiNi₁₋ₓMn₁₊ₓO₄ (VI)

wherein 0<x<1.

More specifically, the oxides of the formulae LiNi_{0.4}Mn_{1.6}O₄ or LiNi_{0.5}Mn_{1.5}O₄ have the particularity of having a lithium insertion/deinsertion potential of the order of 4.7 V (this potential being expressed relatively to the reference pair Li⁺/Li).

As an alternative to the aforementioned lithiated oxides of the aforementioned formula (VI), mention may be made, as a positive electrode active material, of a lithiated oxide of the following formula (VII):

Li₁₋ₓ₂Mn_{1,5-y2}Ni_{0.5-z2}M_{y2+z2}O₄ (VII)

wherein:
x2<1, 0≦y2+z2<0.15; and
M is an element selected from Cr, Mg, Al, Ti, Fe, Co, Ni, Cu, Zn, Ga, Nb, Sn, Zr and Ta.

As other positive electrode active materials, mention may also be made of:
a material of formula LiM¹PO₄, wherein M¹ is a transition element, materials of this type may be LiCoPO₄ or LiNiPO₄;
a material of formula LiM²SO₄X¹, wherein M² is a transition element and X¹ is a halogen element, materials of this type may be LiCoSO₄F, LiNiSO₄F;
a material of formula Li₂M³PO₄X², wherein M³ is a transition element and X² is a halogen element, materials of this type may be Li₂CoPO₄F, Li₂NiPO₄F;
a material of formula Li₃V₂(PO₄)₃, Li₂CoP₂O₇, Li₂NiSiO₄, LiNiVO₄; or
a composite material of formula x₃Li₂MnO₃ (1-x₃)LiMeO₂ with 0≦x₃<1 and Me is an element selected from among Ni, Co, Mn.

In addition to the presence of a material for insertion of lithium, the positive electrode may comprise:
at least one electron conductive material;
at least one binder for ensuring the cohesion between said lithium insertion material and said electron conductive material; and
optionally, electron conductive fibres.

The electron conductive material may preferably be a carbonaceous material, i.e. a material comprising carbon in the elementary state.

As a carbonaceous material, mention may be made of carbon black.

The binder may preferably be a polymeric binder. From among the polymeric binders which may be used, mention may be made of:
fluorinated (co)polymers optionally proton conductors, such as fluorinated polymers like polytetrafluoroethylene (known under the acronym of PTFE), a polyvinylidene fluoride (known under the acronym of PVDF);
elastomeric polymers, such as a styrene-butadiene copolymer (known under the acronym of SBR);
polymers from the family of cellulose, such as carboxymethylcellulose (known under the acronym of CMC); and
mixtures thereof.

The electron conductive fibres when they are present, may further participate in the good mechanical strength of the positive electrode and are selected, for this purpose, so as to have a very large Young's modulus. Fibres adapted to this specificity may be carbon fibres, such as carbon fibres of the Tenax® type or VGCF-H®. The Tenax® carbon fibres contribute to improving the mechanical properties and have good electrical conductivity. The VGCF-H® carbon fibres are fibres synthesised by steam and contribute to improving the thermal and electrical properties, the dispersion and homogeneity.

The negative electrode comprises, as an active material, advantageously, a material which may be a mixed lithium oxide, such as Li₄Ti₅O₁₂.

As an alternative negative electrode active material, mention may be made of carbon, for example in one of its allotropic forms, such as graphite, lithium or a lithium alloy.

In addition to the presence of an active material, the negative electrode may comprise:
at least one electron conductive material;
at least one binder for ensuring the cohesion between said material with insertion of lithium and said electron conductive material; and
optionally, electron conductive fibres.

The electron conductive material, the binder and the optional electron conductive fibres may be of the same nature as those explained above for the positive electrode.

Advantageously, as mentioned above, the positive electrode comprises as an active material, LiNi_{0.4}Mn_{1.6}O₄ or LiNi_{0.5}Mn_{1.5}O₄ and the negative electrode comprises as active material, Li₄Ti₅O₁₂.

Whether this is for the positive electrode or the negative electrode, they may be associated with a current collector, which may appear as a metal sheet. This may notably be a current collector in aluminium.

Within the batteries according to the invention, the electrolyte of the invention may be led in the electrochemical cells of the lithium batteries, such as lithium-ion batteries, to impregnate a separator, which is positioned between the positive electrode and the negative electrode of the electrochemical cell.

This separator may be in a porous material, such as a material in glass fibre, a polymeric material, such as polypropylene, polyethylene, cellulose, able to receive in its porosity the liquid electrolyte. More specifically, this may be a membrane of the Celguard 2400® type.

From among the electrolytes which may enter the composition of the batteries of the invention, certain are novel, these electrolytes being electrolytes conducting lithium ions comprising at least one sulfone solvent, at least one additive selected from among anhydride compounds, at least a lithium salt and further comprising one or several co-solvents which form a mixture with the sulfone solvent(s), said mixture being selected from among an EMS-DMC mixture; an EMS-DEC mixture; a TMS-DMC mixture; an EC-EMS-DMC mixture; an EMS-MIS-DMC mixture; an EMS-EMC mixture; or an MIS-DMC mixture.

In particular, the anhydride additive may be a cyclic or acyclic carboxylic anhydride compound and the anhydride additive may be present according to a content ranging from 0.01% to 30% by mass based on the total mass of the electrolyte.

More specifically, the anhydride additive may be selected from among succinic anhydride, maleic anhydride, glutaric anhydride, phthalic anhydride, benzoic anhydride, ethanoic anhydride, propanoic anhydride, butanoic anhydride, cis-butenedioic anhydride, butane-1,4-dicarboxylic anhydride, pentane-1,5-dicarboxylic anhydride, hexane-1,6-dicarboxylic anhydride, 2,2-dimethylbutane-1,4-dicarboxylic anhydride, 2,2-dimethylpentane-1,5-dicarboxylic anhydride, 4-bromophthalic anhydride, 4-chloroformylphthalic anhydride, 3-methylglutaric anhydride, hexafluoroglutaric anhydride, acetic anhydride, trifluoroacetic anhydride, 2,3-dimethylmaleic anhydride, 2,3-diphenylmaleic anhydride, 2,3-pyrazinedicarboxylic anhydride, 3,3-tetramethyleneglutaric anhydride, difluorophthalic anhydride, benzoglutaric anhydride, phenylsuccinic anhydride, crotonic anhydride, isacoic anhydride, pentafluoropropionic anhydride, propionic anhydride, 3-fluorophthalic anhydride, itaconic anhydride, 2-methylenebutane-1,4-dicarboxylic anhydride and mixtures thereof.

Advantageously, the anhydride additive is succinic anhydride.

The specificities relating to the sulfone solvent(s), the lithium salt(s) may be repeated in the part relating to the description of the batteries as such.

Particular electrolytes according to the invention may be:
an electrolyte comprising an EMS-DMC mixture (for example, in a mass proportion 1:1), succinic anhydride (1% by mass based on the total mass of the electrolyte) and LiPF₆ 1M;
an electrolyte comprising an EMS-DEC mixture (for example, in mass proportions of 1:1), succinic anhydride (1% by mass based on the total mass of the electrolyte) and LiPF₆ 1M;
an electrolyte comprising a TMS-DMC mixture (for example, in mass proportions of 1:1), succinic anhydride (1% by mass based on the total mass of the electrolyte) and LiPF₆ 1M;
an electrolyte comprising an EC-EMS-DMC mixture (for example, in mass proportions of 1:1:3), succinic anhydride (1% by mass based on the total mass of the electrolyte) and LiPF₆ 1M;
an electrolyte comprising an EMS-MIS-DMC mixture (for example, in mass proportions of 2:3:5), succinic anhydride (1% by mass based on the total mass of the electrolyte) and LiPF₆ 1M;
an electrolyte comprising an EMS-EMC mixture (for example, in mass proportions of 1:1), succinic anhydride (1% by mass based on the total mass of the electrolyte) and LiPF₆ 1M; or
an electrolyte comprising an MIS-DMC mixture (for example, in mass proportions of 2:3), succinic anhydride (1% by mass based on the total mass of the electrolyte) and LiPF₆ 1M.

The invention will now be described with reference to the following examples, given as indication and not as a limitation.

### SHORT DESCRIPTION OF THE FIGURES

FIG. 1 is a graph illustrating, for the tests of example 1, the time-dependent change in the capacity C (in mAh/g) at 20° C. according to number of cycles N, the curves a) illustrating the charging-discharging curves for the battery according to the invention while the curves b) illustrate the charging-discharging curves for the battery not compliant with the invention.

FIG. 2 is a graph illustrating, for the tests of example 2, the time-dependent change in the potential U (in V) versus the capacity C (in mAh/g) at 20° C. of batteries during a first cycle comprising a charging phase and a discharge phase, said phases being interrupted by a period of 14 days in an open circuit at 20° C. (curves a) of charging-discharging for the first battery of the invention, curves b) of charging-discharging of the second battery according to the invention and curve c) of charging-discharging for the battery not compliant with the invention).

FIG. 3 is a graph illustrating, for the tests of example 3, the time-dependent change in the potential U (in V) versus the capacity C (in mAh/g) at 20° C. of batteries during a first cycle comprising a charging phase and a discharge phase, said phases being interrupted by a period of 14 days in open circuit conditions at 20° C. (curves a) of charging-discharging for the first battery of the invention, curves b) of charging-discharging of the second battery according to the invention and curves c) of charging-discharging for the battery not compliant with the invention).

FIG. 4 is a graph illustrating the time-dependent change in the potential U (in V) versus the capacity C (in mAh/g) at 20° C. of a battery according to the invention subject to two tests as explained in example 4.

FIG. 5 is a graph illustrating, for the example 5, the time-dependent change of the potential U (in V relatively to LTO) versus time t (expressed in seconds), during 30 cycles, the curve of each cycle comprising an ascending phase (this corresponds to the charging phase) and a descending phase (this corresponds to the discharge phase) for a battery according to the invention.

### DETAILED DISCUSSION OF PARTICULAR EMBODIMENTS

The examples which follow, were applied for illustrating the contribution of an anhydride compound as an additive in an electrolyte based on at least one sulfone compound for lithium-ion batteries comprising high potential electrodes.

The goals targeted by these examples are:
to demonstrate the performances of an electrolyte based on cyclic or linear sulfone compound(s) in a lithium-ion battery as compared with an electrolyte based on carbonate solvent(s);
to demonstrate the contribution of an anhydride additive in an electrolyte based on linear or cyclic sulfone compound(s) in a lithium-ion battery;
to demonstrate the improvement in the performances of a lithium-ion battery by the contribution of an anhydride additive in an electrolyte based on linear or cyclic sulfone compound(s) as compared with an electrolyte always based on linear or cyclic sulfone compound(s) but comprising a conventional additive for electrolytes of the carbonate type.

In these examples, particular care is brought to the purity of each constituent entering the composition of the electrolytes, notably at the solvents, which are distilled and then dried on a molecular sieve, from the moment that they have a purity of less than 99.9%.

### Example 1

This example, with a comparative goal, has the purpose of comparing the performances:
of a lithium-ion battery using an electrolyte according to the invention (i.e., an electrolyte comprising a mixture of ethylmethylsulfone (symbolized subsequently by EMS) and of dimethyl carbonate (symbolized subsequently by DMC) (in mass proportions 1:1) comprising LiPF₆ 1M and 1% by mass of succinic anhydride (symbolized subsequently by AS); and

of a lithium-ion battery using an electrolyte non-compliant with the invention (i.e., an electrolyte comprising a mixture of ethylmethylsulfone (symbolized subsequently by EMS) and of dimethyl carbonate (symbolized subsequently by DMC) (in mass proportions 1:1) comprising LiPF₆ 1M and 1% by mass of vinylene carbonate (symbolized, subsequently by VC).

The presentation of this example is divided into three portions:

1^{∘}) Preparation of the electrolyte according to the invention and of the battery comprising it;

2^{∘}) Preparation of the electrolyte not compliant with the invention and of the battery comprising it;

3^{∘}) Results relating to the cyclability performances.

1^{∘}) Preparation of the Electrolyte According to the Invention and of the Battery Comprising it

a) Supply and Preparation of the Components

Ethylmethylsulfone (EMS) is supplied by the company TCI (Tokyo Industry, Co, Ltd, Japan). This solvent is distilled in order to attain a purity of more than 99.9% verified by gas chromatography coupled with mass spectrometry.

Ethylmethylsulfone (EMS) is then conditioned in a glass vial under argon, said vial containing a drying agent (as a molecular sieve). The H₂O concentration is regularly measured by the Karl-Fischer method and is less than 20 ppm.

Before its use, ethylmethylsulfone (EMS) is heated beforehand to 60° C. because of its high melting point (of the order of 34° C.).

The dimethyl carbonate (DMC) of “battery grade” (i.e. a purity of 99.9%) originates from Merck. The solvent is conditioned in its initial packing (i.e., an aluminium bottle) in a glove box and is used without any specific treatment.

Succinic anhydride (AS) is supplied by the company Alfa Aesar. The additive is conditioned in its original packing (i.e., an aluminium bottle) in a glove box and is used without any specific treatment.

The salt LiPF₆ is from Fluorochem. This salt is conditioned in its original package (i.e., a plastic bottle) in a glove box and is used without any specific treatment.

b) Development of the Electrolyte

The development and the preparation of the electrolyte are achieved under dry argon in a glove box.

In a first phase, the EMS and DMC solvents are associated according to mass proportions of 1:1. The LiPF₆ salt is added until a concentration of 1M is attained. Next succinic anhydride is added so as to attain a content of succinic anhydride of 1% by mass based on the total mass of the electrolyte.

The thereby obtained electrolyte is conditioned in an aluminium flask and is stored for several hours before its use.

This electrolyte forms a dissociating mixture with a dielectric constant close to 30 and not very viscous (a salt-free viscosity of less than 2 mPa·s).

The H₂O and HF contents of the electrolyte (measured by the Schmidt and Oesten method) are verified before electrochemical evaluation in a button cell. The H₂O content is less than 20 ppm and the HF content is less than 50 ppm.

c) Production of the Battery

The electrolyte is introduced within a button cell of the 2032 type.

The positive electrode of the button cell comprises the active material LiNi_{0.4}Mn_{1.6}O₄, super P carbon, Tenax fibres and a polyvinylidene fluoride binder (PVDF) in an amount of the respective mass contents: 89%, 3%, 3% and 5%, these contents being expressed based on the total mass of the positive electrode. The positive electrode appears as a disc with a diameter of 14 mm, which electrode is supported by a current collector in aluminium.

The negative electrode of the button cell comprises the active material Li₄Ti₅O₁₂, the super P carbon, Tenax fibres and a polyvinylidene fluoride binder (PVDF), in an amount of the respective mass contents: 82%, 6%, 6% and 6%, these contents being expressed based on the total mass of the negative electrode. The positive electrode appears as a disc with a diameter of 16 mm, which electrode is supported by a current collector in aluminium.

The positive electrode and the negative electrode are separated by a disc of Celgard 2400® and a disc in Viledon®, the diameters of which are 16.5 mm and the respective thicknesses are 20 and 230 μm. The separator formed with the two aforementioned discs is impregnated with the electrolyte (150 μL) during the assembling of the button cell in a glove box.

2^{∘}) Preparation of the Electrolyte not Compliant with the Invention and of the Battery Comprising it

The electrolyte and the battery comprising it are made in a way similar to those of paragraph 1^{∘}) above, except that succinic anhydride (AC) is replaced with vinylene carbonate (VC).

Vinylene carbonate (VC) is supplied by ACros Organics. It is conditioned in its original package (i.e., a glass bottle) in a glove box and is used without any specific treatment.

3^{∘}) Results Concerning the Cyclability Performances

With the batteries made in paragraph 1^{∘}) and 2^{∘}), tests are conducted for determining the time-dependent change in the charging and discharge capacity, these tests being conducted at 20° C. under conditions of C/5-D/5.

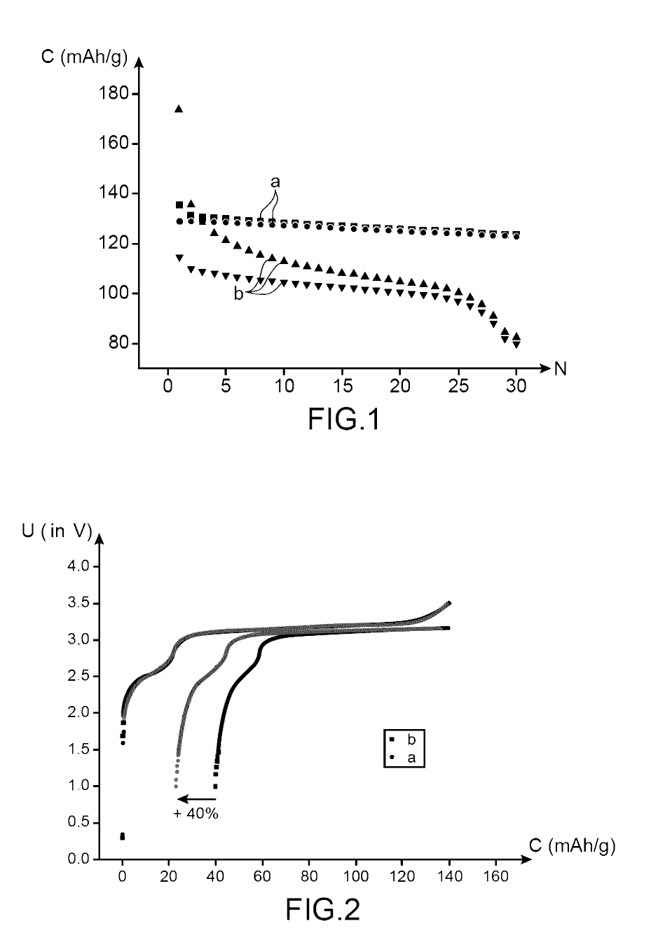

The results are transferred onto FIG. 1 illustrating the time-dependent change of the capacity C (in mAh/g) versus the number of cycles, the curves a) illustrating the charging-discharging curves for the battery according to the invention, while the curves b) illustrate the charging-discharging curves for the battery not compliant with the invention.

It clearly appears that the battery according to the invention has better cyclability as compared with the battery comprising as an additive, vinylene carbonate.

Indeed, the capacity after 30 cycles is of about 123 mAh/g with the battery according to the invention, while it attains a value of less than 90 mAh/g with a battery comprising, as an additive, vinylene carbonate.

### Example 2

This example, with a comparative intention, has the purpose of comparing the performances:
of a lithium-ion battery using an electrolyte according to the invention (i.e., an electrolyte comprising a mixture of ethylmethylsulfone (symbolized, subsequently, by EMS) and of dimethyl carbonate (symbolized, subsequently by DMC) in mass proportions comprising LiPF₆ 1M and 1% of succinic anhydride (symbolized, subsequently by AS); and
of a lithium-ion battery using an electrolyte not compliant with the invention (i.e., an electrolyte comprising a mixture of ethylmethylsulfone (symbolized, subsequently by EMS) and of dimethyl carbonate (symbolized, subsequently by DMC) (in mass proportions 1:1) comprising LiPF₆ 1M.

The battery according to the invention is prepared in the same way as the one of example 1.

The battery not compliant with the invention is prepared in the same way as the battery according to the invention, except that it is not proceeded with the addition of succinic anhydride.

With these batteries, tests are carried out aiming at determining the time-dependent change of the capacity at 20° C. of the aforementioned batteries during a first cycle comprising a charging phase and a discharge phase, said phases being interrupted by a period of 14 days in an open circuit at 20° C., as illustrated in FIG. 2 (curves a) of charging-discharging for the battery of the invention U (in V) versus the capacity C (in mAh/g) and curves b) of charging-discharging of the battery not compliant with the invention U (in V) versus the capacity C (in mAh/g).

Upon considering this figure, it clearly appears that the battery of the invention gives the possibility of reducing the self-discharge phenomenon (i.e., the loss of capacity during the period in an open circuit) relatively to the battery not compliant with the invention, the loss of capacity for the latter being of the order of 40%.

Without being bound by theory, the batteries of the invention induce the formation of an efficient electrode-electrolyte interface as soon as the first cycle versus the various phenomena leading to self-discharge of the battery (for example, degradation of the electrolyte, electrochemical boat phenomena).

### Example 3

This example with a comparative intention, has the purpose of comparing the performances:
of a first lithium-ion battery using an electrolyte according to the invention (i.e., an electrolyte comprising a mixture of ethylmethylsulfone (symbolized, subsequently, by EMS) and of dimethyl carbonate (symbolized, subsequently, by DMC) (in mass proportions 1:1) comprising LiPF₆ 1M and 1% by mass of succinic anhydride (symbolized, subsequently, by AS);
of a second lithium-ion battery using an electrolyte according to the invention (i.e., an electrolyte comprising a mixture of ethylmethylsulfone (symbolized, subsequently by EMS) and of dimethyl carbonate (symbolized, subsequently by DMC) (in mass proportions 1:1) comprising LiPF₆ 1M and 0.1% by mass of succinic anhydride (symbolized, subsequently by AS); and
of a lithium-ion battery using an electrolyte not compliant with the invention (i.e., an electrolyte comprising a mixture of ethylmethylsulfone (symbolized, subsequently by EMS) and of dimethyl carbonate (symbolized, subsequently by DMC) (in mass proportions 1:1) comprising LiPF₆ 1M.

The first battery according to the invention is prepared in the same way as the one of example 1.

The second battery according to the invention is prepared in the same way as the one of example 1, except that only 0.1% by mass of succinic anhydride is added.

The battery not compliant with the invention is prepared in the same way as the battery according to the invention, except that it is not proceeded with the addition of succinic anhydride.

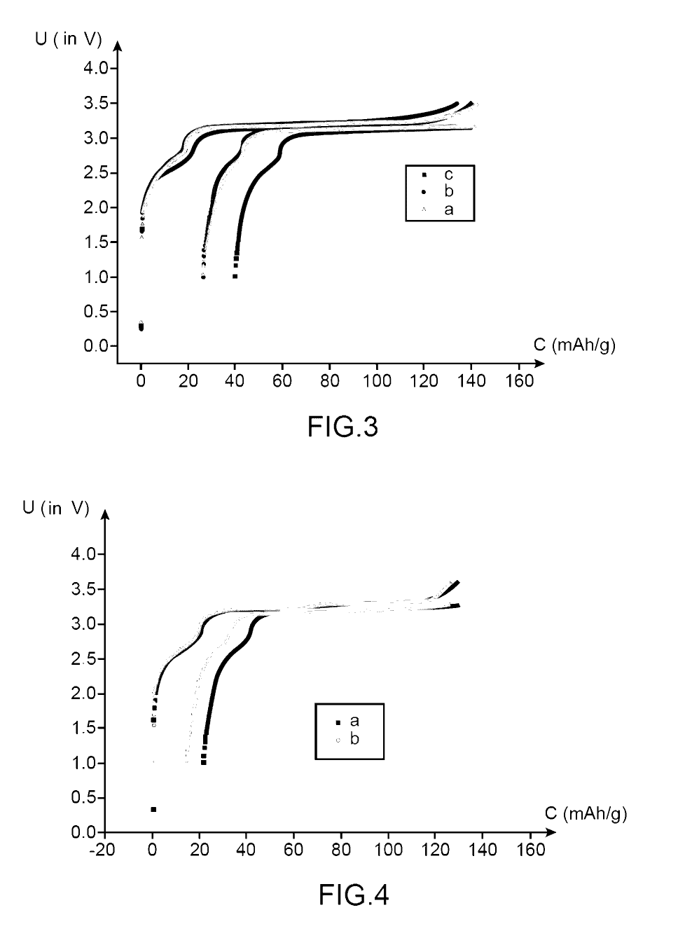

With these batteries, tests are conducted aiming at determining the time-dependent change of the capacity at 20° C. of the aforementioned batteries during a first cycle comprising a charging phase and a discharge phase, said phases being interrupted by a period of 14 days in an open circuit at 20° C., as illustrated in FIG. 3 (curves a) of charging-discharging U (in V) versus the capacity C (in mAh/g) for the first battery of the invention, curves b) of charging-discharging U (in V) versus the capacity C (in mAh/g) of the second battery according to the invention and curves c) of charging-discharging U (in V) versus the capacity C (in mAh/g) for the battery non-compliant with the invention).

Considering this figure, it clearly appears that the batteries of the invention give the possibility of reducing the self-discharge phenomenon (i.e., the loss of capacity during the period in an open circuit) relatively to the battery not compliant with the invention, and this even from addition of a small amount of succinic anhydride (for example, 0.1%), the efficiency being the same in this case than for the addition of 1% of succinic anhydride (the curves a) and b) being superposed in FIG. 3).

### Example 4

This example is aimed at demonstrating the influence of the cycling before storage on the self-discharge of a battery comprising an electrolyte according to the invention as defined in example 1.

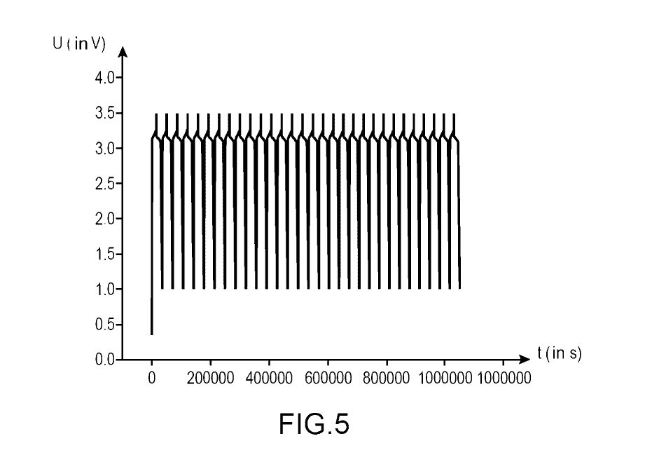

It is proceeded with two tests:
a first test consisting of charging the battery, putting it in an open circuit for 14 days and then discharging the battery; (cf. curves a) U (in V) versus the capacity C (in mAh/g) of FIG. 4 illustrating the charging phase and the discharge phase); and
a second test consisting of performing 4 charging-discharging cycles, a charging of the battery, putting it in open circuit for 14 days and then discharge of the battery (curves b) U (in V) versus the capacity C (in mAh/g) of FIG. 4).

These tests are conducted at 20° C. with, for the chargings, conditions of C/5 and for the discharges, conditions of D/5.

The results of these tests are illustrated in FIG. 4 with:
for the curves a), the charging phase and the discharge phase of the first test, both of these charging processes being interrupted by putting it in an open circuit for 14 days;
for the curves b), the charging phase and the discharge phase of the second test, both of these charging processes being interrupted by putting it in an open circuit for 14 days (the 4 charging-discharge cycling processes are not illustrated in this figure).

It appears that the preliminary cycling processes of the battery before putting it in an open circuit give the possibility of more efficiently reducing the self-discharge notably by means of the improvement of the electrode-electrolyte interface.

### Example 5

This example has the aim of demonstrating the performances of cyclability of a battery comprising an electrolyte according to the invention as defined in example 1.

To do this, the relevant battery was subject to 30 charging-discharge cycles under conditions of C/5-D/5.

The charging-discharge curves are transferred onto FIG. 5, which represents the time-dependent change of the potential U (in V relatively to LTO) versus time t (expressed in seconds), during 30 cycles, the curve of each cycle comprising an ascending phase (this corresponds to the charging phase) and a descending phase (this corresponds to the discharge phase).

Each curve has an identical shape, which certifies good performances of cyclability of the battery comprising an electrolyte according to the invention.

Furthermore, the Coulomb efficiency of the battery, after 30 cycles, is 99.3%.

### Example 6

This example has the purpose of demonstrating that:

1^{∘}) the electrolytes based on sulfone solvent(s) comprising an anhydride additive have better performances notably in terms of loss of capacities after a certain number of cycling processes relatively to electrolytes comprising the same sulfone solvent(s) but without any additive; and

2^{∘}) the electrolytes based on sulfone solvent(s) comprising an anhydride additive have better performances notably in terms of loss of capacities after a certain number of cycling processes as compared with electrolytes comprising the same sulfone solvent(s) comprising a conventional additive for electrolytes of the carbonate type.

In order to demonstrate point 1^{∘}), the following electrolytes were tested:
an electrolyte comprising a mixture of ethylmethylsulfone (symbolized, subsequently by EMS) and of dimethyl carbonate (symbolized, subsequently by DMC) (in mass proportions 1:1) comprising LiPF₆ 1M and an electrolyte comprising the same ingredients with in addition 1% by mass of succinic anhydride;
an electrolyte comprising a mixture of ethylmethylsulfone (symbolized, subsequently by EMS) and of diethyl carbonate (symbolized, subsequently by DEC) (in mass proportions 1:1) comprising LiPF₆ 1M and an electrolyte comprising the same ingredients with additionally 1% by mass of succinic anhydride;
an electrolyte comprising a mixture of tetramethylene sulfone (symbolized, subsequently by TMS) and of dimethyl carbonate (symbolized, subsequently by DMC) (in mass proportions 1:1) comprising LiPF₆ 1M and an electrolyte comprising the same ingredients with, additionally, 1% by mass of succinic anhydride;
an electrolyte comprising a mixture of ethylene carbonate (symbolized, subsequently by EC) of ethylmethylsulfone (symbolized, subsequently by EMS) and of dimethyl carbonate (symbolized, subsequently by DMC) (in mass proportions 1:1:3) comprising LiPF₆ 1M and an electrolyte comprising the same ingredients with additionally 1% by mass of succinic anhydride; and
an electrolyte comprising a mixture of ethylmethylsulfone (symbolized, subsequently by EMS), methyl isopropyl sulfone (symbolized, subsequently by MIS) and of dimethyl carbonate (symbolized, subsequently by DMC) (in mass proportions 2:3:5) comprising LiPF₆ 1M and an electrolyte comprising the same ingredients with additionally, 1% by mass of succinic anhydride.

The electrolytes are prepared prior to applying the tests.

The electrolyte comprising a mixture of ethylmethylsulfone (symbolized, subsequently by EMS) and of dimethyl carbonate (symbolized, subsequently by DMC) (in mass proportions 1:1) comprising LiPF₆ 1M and the electrolyte comprising the same ingredients with additionally 1% by mass of succinic anhydride are prepared according to what is explained in examples 1 and 2.

The electrolyte comprising a mixture of ethylmethylsulfone (symbolized, subsequently by EMS) and of diethyl carbonate (symbolized, subsequently by DEC) (in mass proportions 1:1) comprising LiPF₆ 1M and the electrolyte comprising the same ingredients with additionally 1% by mass of succinic anhydride are prepared in the same way as the embodiments of examples 1 and 2, except that dimethyl carbonate is replaced with diethyl carbonate.

The electrolyte comprising a mixture of tetramethylene sulfone (symbolized, subsequently by TMS) and of dimethyl carbonate (symbolized, subsequently by DMC) (in mass proportions 1:1) comprising LiPF₆ 1M and an electrolyte comprising the same ingredients with, additionally, 1% by mass of succinic anhydride are prepared in the same way as the embodiments of examples 1 and 2, except that ethylmethylsulfone is replaced with tetramethylene sulfone.

The electrolyte comprising a mixture of ethylene carbonate (symbolized, subsequently by EC) of ethylmethylsulfone (symbolized, subsequently by EMS) and of dimethyl carbonate (symbolized, subsequently by DMC) (in mass proportions 1:1:3) comprising LiPF₆ 1M and an electrolyte comprising the same ingredients with, additionally, 1% by mass of succinic anhydride, are prepared in the same way as the embodiments of examples 1 and 2, and except that ethylene carbonate is added.

The electrolyte comprising a mixture of ethylmethylsulfone (symbolized, subsequently by EMS), methyl isopropyl sulfone (symbolized, subsequently by MIS) and of dimethyl carbonate (symbolized, subsequently by DMC) (in mass proportions 2:3:5) comprising LiPF₆ 1M and an electrolyte comprising the same ingredients with, additionally, 1% by mass of succinic anhydride are prepared in the same way as the embodiments of examples 1 and 2, except that methyl isopropyl sulfone is added.

These different electrolytes are tested on a lithium-ion battery of same nature as the one explained in example 1. The percentage of loss of capacity between the first discharge and the 30^{th} discharge at 20° C. is determined respectively with conditions C/5-D/5. The Coulomb efficiency is also determined.

The results are given in the table below.

| Electrolyte | | | Tests | |
|---|---|---|---|---|
| | | Additive | % of loss | Coulomb |
| Mixture of | | (in mass | of | efficiency |
| solvents | Salt | %) | capacity | (in %) |
| EMS/DMC | 1M | 0% | 0.9 | 99.3 |
| | LiPF₆ | | | |
| EMS/DMC | 1M | 1% AS | 0 | 99.3 |
| | LiPF₆ | | | |
| EMS/DEC | 1M | 0% | 0.9 | 99.5 |
| | LiPF₆ | | | |
| EMS/DEC | 1M | 1% AS | 0.1 | 99.3 |
| | LiPF₆ | | | |
| TMS/DMC | 1M | 0% | 0.6 | 99.1 |
| | LiPF₆ | | | |
| TMS/DMC | 1M | 1% AS | −0.5 | 99.5 |
| | LiPF₆ | | | |
| EC/EMS/3DMC | 1M | 0% | 3.2 | 99.1 |
| | LiPF₆ | | | |
| EC/EMS/3DMC | 1M | 1% AS | 2 | 99.3 |
| | LiPF₆ | | | |
| 2EMS/3MIS/5DMC | 1M | 0% | −1.8 | 99.1 |
| | LiPF₆ | | | |
| 2EMS/3MIS/5DMC | 1M | 1% AS | −1 | 99.4 |
| | LiPF₆ | | | |

Considering this table, it is clearly apparent that for an electrolyte comprising a mixture of solvents for which at least one of the solvents is a sulfone solvent, the addition of an anhydride additive gives the possibility of reducing the losses of capacity of a battery after a significant number of cycling processes.

As to Coulomb efficiency, it remains of the same order of magnitude, regardless of whether the anhydride additive is present or not, which confirms the fact that this additive does not have a negative effect on this criterion.

In order to demonstrate the point 2^{∘}), an electrolyte was tested comprising a mixture of ethylmethylsulfone (symbolized, subsequently by EMS) and of dimethyl carbonate (symbolized, subsequently by DMC) (in mass proportions 1:1) comprising LiPF₆ 1M and 1% by mass of succinic anhydride and an electrolyte comprising a mixture of ethylmethylsulfone (symbolized, subsequently by EMS) and of dimethyl carbonate (symbolized, subsequently by DMC) (in mass proportions 1:1) comprising LiPF₆ 1M and 1% by mass of vinylene carbonate.

For the latter, the loss of capacity is of 30%, which confirms the efficiency of the anhydride additive in an electrolyte as compared with the vinylene carbonate additive.

### Example 7

This example has the purpose of demonstrating that:

1^{∘}) the electrolytes based on sulfone solvent(s) comprising an anhydride additive have better performances notably in terms of loss of capacities after a certain number of cycling processes as compared with electrolytes comprising the same sulfone solvent(s) but without any additive; and

2^{∘}) the electrolytes based on sulfone solvent(s) comprising an anhydride additive have better performances notably in terms of self-discharge and irreversibility as compared with electrolytes only comprising carbonate solvents.

In order to demonstrate point 1^{∘}), the same electrolytes as those of point 1^{∘}) of example 6 are used with additionally the EMS/DMC, LiPF₆ 1M electrolyte comprising 0.1% of AS.

These electrolytes are incorporated in a battery similar to the one of example 6. It has been determined, at 20° C., respectively the charging capacity after 14 days of having been put in an open circuit C_{charge}14OCV (in mAh/g), the discharge capacity after 14 days of being put in an open circuit C_{Discharge}14OCV (in mAh/g), the self-discharge percent %_{self} and the irreversibility percent between the capacity of the first charging process and the capacity of the second charging process after 14 days of being put in an open circuit %ᵢᵣᵣ.

The results appear in the table below.

| Electrolyte | | | | | | | |
|---|---|---|---|---|---|---|---|
| | | Additive | | Tests | | | |
| Mixture of | | (in mass | | C_{Charge} | C_{Discharge} | | |
| solvents | Salt | %) | | 14OCV | 14OCV | %_{self} | %ᵢᵣᵣ |
| EMS/DMC | 1M | 0% | | 140 | 100 | 28 | 6 |
| | LiPF₆ | | | | | | |
| EMS/DMC | 1M | 0.1% | AS | 138 | 113 | 18 | 3 |
| | LiPF₆ | | | | | | |
| EMS/DMC | 1M | 1% | AS | 139 | 116 | 16 | 3 |
| | LiPF₆ | | | | | | |
| EMS/DEC | 1M | 0% | | 137 | 85 | 38 | 6 |
| | LiPF₆ | | | | | | |
| EMS/DEC | 1M | 1% | AS | 140 | 111 | 20 | 5 |
| | LiPF₆ | | | | | | |
| TMS/DMC | 1M | 0% | | 139 | 98 | 30 | 4 |
| | LiPF₆ | | | | | | |
| TMS/DMC | 1M | 1% | AS | 140 | 117 | 15 | 0.8 |
| | LiPF₆ | | | | | | |
| EC/EMS/3DMC | 1M | 0% | | 140 | 112 | 20 | 5 |
| | LiPF₆ | | | | | | |
| EC/EMS/3DMC | 1M | 1% | AS | 142 | 112 | 18 | 5 |
| | LiPF₆ | | | | | | |
| 2EMS/3MIS/ | 1M | 0% | | 129 | 85 | 41 | 7 |
| 5DMC | LiPF₆ | | | | | | |
| 2EMS/3MIS/ | 1M | 1% | AS | 137 | 112 | 14 | 3 |
| 5DMC | LiPF₆ | | | | | | |

The introduction of the anhydride additive significantly improves the performances in self-discharge with notably a reduction of about half of the self-discharge phenomenon with binary mixtures comprising a sulfone solvent.

In order to demonstrate the point 2^{∘}), an electrolyte was tested comprising a mixture of carbonate solvents EC/DMC (in mass proportions 1:1) comprising LiPF₆ 1M and 1% by mass of succinic anhydride. Relatively to the EMS/DMC electrolyte, the self-discharge percent is clearly more significant (24 versus 16), which demonstrates the efficiency of the addition of an anhydride additive in an electrolyte based on sulfone solvent(s) as compared with an electrolyte only comprising carbonate solvents.

1: A lithium battery, comprising
at least one electrochemical cell comprising an electrolyte suitable for conducting lithium ions,
the electrolyte comprising at least one sulfone solvent, at least one anhydride additive and at least one lithium salt,
wherein the electrolyte is positioned between a positive electrode comprising, as an active material, a lithiated oxide of formula LiNi_{0.4}Mn_{1.6}O₄ or LiNi_{0.5}Mn_{1.5}O₄ and a negative electrode comprising, as an active material Li₄Ti₅O₁₂.

2: The battery according to claim 1, wherein the sulfone solvent is a cyclic sulfone solvent or a linear sulfone solvent.

3: The battery according to claim 2, wherein the sulfone solvent comprises a cyclic sulfone solvent of formula (I): 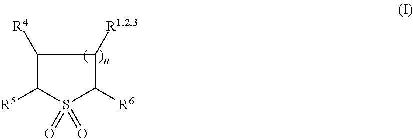
wherein:
R¹, R⁴, R⁵, R⁶ and, if present R² and R³ represent, independently of each other, a hydrogen atom, a halogen atom or an alkyl group;
n is an integer ranging from 1 to 3.

4: The battery according to claim 1, wherein the sulfone solvent is tetramethylsulfone.

5: The battery according to claim 1, wherein the electrolyte comprises a mixture of cyclic sulfones.

6: The battery according to claim 1, wherein the sulfone solvent is a symmetrical or asymmetrical linear sulfone solvent.

7: The battery according to claim 1, wherein the sulfone solvent is a linear sulfone solvent of formula (V):
R⁷—SO₂—R⁸ (V)
wherein R⁷ and R⁸ represent, independently of each other, an alkyl group comprising from 1 to 7 carbon atoms optionally comprising one or several halogen atoms, or an aryl group optionally comprising one or several halogen atoms.

8: The battery according to claim 1, wherein the sulfone solvent comprises, as a linear sulfone solvent, ethylmethylsulfone, di(n-butyl)sulfone, methylisopropylsulfone, ethylisopropylsulfone, diethylsulfone, di-n-propylsulfone, dimethylsulfone, or 2-fluorophenylmethylsulfone.

9: The battery according to claim 1, wherein the sulfone solvent is at least one linear sulfone solvent selected from the group consisting of ethylmethylsulfone and methylisopropylsulfone.

10: The battery according to claim 1, wherein the electrolyte further comprises one or several more co-solvents, which are not sulfone solvents.

11: The battery according to claim 10, wherein the one or more co-solvents are carbonate solvents.

12: The battery according to claim 10, wherein the one or more co-solvents are carbonate solvents selected from the group consisting of linear carbonate solvents and cyclic carbonate solvents.

13: The battery according to claim 12, wherein the one or more co-solvents are cyclic carbonate solvents selected from the group consisting of ethylene carbonate (EC), propylene carbonate (PC) and mixtures thereof.

14: The battery according to claim 12, wherein the one or more co-solvents are linear carbonate solvents selected from the group consisting of dimethyl carbonate (DMC), diethyl carbonate (DEC), ethylmethylcarbonate (EMC) and mixtures thereof.

15: The battery according to claim 10, wherein the electrolyte comprises one or more co-solvents which form a mixture with the sulfone solvent, said mixture being selected from the group consisting of:
an EMS-DMC mixture;
an EMS-DEC mixture;
a TMS-DMC mixture;
an EC-EMS-DMC mixture;
an EMS-MIS-DMC mixture;
an EMS-EMC mixture; and
an MIS-DMC mixture.

16: The battery according to claim 1, wherein the anhydride additive is a cyclic or acyclic carboxylic anhydride compound.

17: The battery according to claim 1, wherein the anhydride additive is present according to a content ranging from 0.01% to 30% by mass based on the total mass of the electrolyte.

18: The battery according to claim 1, wherein the anhydride additive is at least one selected from the group consisting of succinic anhydride, maleic anhydride, glutaric anhydride, phthalic anhydride, benzoic anhydride, ethanoic anhydride, propanoic anhydride, butanoic anhydride, cis-butenedioic anhydride, butane-1,4-dicarboxylic anhydride, pentane-1,5-dicarboxylic anhydride, hexane-1,6-dicarboxylic anhydride, 2,2-dimethylbutane-1,4-dicarboxylic anhydride, 2,2-dimethylpentane-1,5-dicarboxylic anhydride, 4-bromophthalic anhydride, 4-chloroformylphthalic anhydride, 3-methylglutaric anhydride, hexafluoroglutaric anhydride, acetic anhydride, trifluoroacetic anhydride, 2,3-dimethylmaleic anhydride, 2,3-diphenylmaleic anhydride, 2,3-pyrazinedicarboxylic anhydride, 3,3-tetramethyleneglutaric anhydride, difluorophthalic anhydride, benzoglutaric anhydride, phenylsuccinic anhydride, crotonic anhydride, isacoic anhydride, pentafluoropropionic anhydride, propionic anhydride, 3-fluorophthalic anhydride, itaconic anhydride, 2-methylenebutane-1,4-dicarboxylic anhydride and mixtures thereof.

19: The battery according to claim 1, wherein the anhydride additive is succinic anhydride.

20: The battery according to claim 1, wherein the electrolyte is:
an electrolyte comprising an EMS-DMC mixture, succinic anhydride and LiPF₆ 1M;
an electrolyte comprising an EMS-DEC mixture, succinic anhydride and LiPF₆ 1M;
an electrolyte comprising a TMS-DMC mixture, succinic anhydride and LiPF₆ 1M;
an electrolyte comprising an EC-EMS-DMC mixture, succinic anhydride and LiPF₆ 1M;
an electrolyte comprising an EMS-MIS-DMC mixture, succinic anhydride and LiPF₆ 1M;
an electrolyte comprising an EMS-EMC mixture, succinic anhydride and LiPF₆ 1M; or
an electrolyte comprising an MIS-DMC mixture, succinic anhydride and LiPF₆ 1M.

21: An electrolyte conducting lithium ions the electrolyte comprising:
at least one sulfone solvent,
at least one anhydride additive,
at least one lithium salt and
one or more co-solvents which form a mixture with the at least one sulfone solvent, said mixture selected from the group consisting of an EMS-DMC mixture; an EMS-DEC mixture; a TMS-DMC mixture; an EC-EMS-DMC mixture; an EMS-MIS-DMC mixture; an EMS-EMC mixture; and an MIS-DMC mixture.

22: The electrolyte according to claim 21, wherein the anhydride additive is a cyclic or acyclic carboxylic anhydride compound.

23: The electrolyte according to claim 21, wherein the anhydride additive is present in a content ranging from 0.01% to 30% by mass based on the total mass of the electrolyte.

24: The electrolyte according to claim 21, wherein the anhydride additive is at least one selected from the group consisting of succinic anhydride, maleic anhydride, glutaric anhydride, phthalic anhydride, benzoic anhydride, ethanoic anhydride, propanoic anhydride, butanoic anhydride, cis-butenedioic anhydride, butane-1,4-dicarboxylic anhydride, pentane-1,5-dicarboxylic anhydride, hexane-1,6-dicarboxylic anhydride, 2,2-dimethylbutane-1,4-dicarboxylic anhydride, 2,2-dimethylpentane-1,5-dicarboxylic anhydride, 4-bromophthalic anhydride, 4-chloroformylphthalic anhydride, 3-methylglutaric anhydride, hexafluoroglutaric anhydride, acetic anhydride, trifluoroacetic anhydride, 2,3-dimethylmaleic anhydride, 2,3-diphenylmaleic anhydride, 2,3-pyrazinedicarboxylic anhydride, 3,3-tetramethyleneglutaric anhydride, difluorophthalic anhydride, benzoglutaric anhydride, phenylsuccinic anhydride, crotonic anhydride, isacoic anhydride, pentafluoropropionic anhydride, propionic anhydride, 3-fluorophthalic anhydride, itaconic anhydride, 2-methylenebutane-1,4-dicarboxylic anhydride and mixtures thereof.

25: The electrolyte according to claim 21, wherein the anhydride additive is succinic anhydride.

26: The electrolyte according to claim 21, which is:
an electrolyte comprising an EMS-DMC mixture, succinic anhydride and LiPF₆ 1M;
an electrolyte comprising an EMS-DEC mixture, succinic anhydride and LiPF₆ 1M;
an electrolyte comprising a TMS-DMC mixture, succinic anhydride and LiPF₆ 1M;
an electrolyte comprising an EC-EMS-DMC mixture, succinic anhydride and LiPF₆ 1M;
an electrolyte comprising an EMS-MIS-DMC mixture, succinic anhydride and LiPF₆ 1M;
an electrolyte comprising an EMS-EMC mixture, succinic anhydride and LiPF₆ 1M; or
an electrolyte comprising a MIS-DMC mixture, succinic anhydride and LiPF₆ 1M.
